(19) United States
(12) Patent Application Publication
(10) Pub. No.: US 2025/0391032 A1
(43) Pub. Date: Dec. 25, 2025

(54) ULTRASOUND SEGMENTATION FOR AN ANATOMICAL STRUCTURE THAT CHANGES SHAPES

(71) Applicant: GE Precision Healthcare LLC, Waukesha, WI (US)

(72) Inventor: Hani Mirar, Oslo (NO)

(21) Appl. No.: 18/753,818

(22) Filed: Jun. 25, 2024

(51) Int. Cl. G06T 7/149; G06T 7/00

(52) U.S. Cl. CPC G06T 7/149; G06T 7/0012; G06T 2207/10136

(57) ABSTRACT

A method for segmenting a moving anatomical structure includes: determining a contour of a first boundary; establishing a plurality of landmark groups extending outwardly from the first boundary towards a second boundary, each of the plurality of landmark groups includes a plurality of landmarks, each of the landmarks corresponds to a given anatomical region; tracking locations of each of the plurality of landmarks over time in cine ultrasound data to determine a motion characteristic for each of the plurality of landmarks; for each of the plurality of landmark groups, determining a difference between the motion characteristics of two adjacent landmarks to determine a corresponding transition point of the second boundary; and approximating the second boundary using the plurality of transition points.

### FIELD

Certain embodiments relate to ultrasound imaging. More specifically, certain embodiments relate to techniques for segmenting anatomical structures (e.g., organs) in ultrasound image data, where those structures change shapes in a patient over time (e.g., the heart).

### BACKGROUND

In ultrasound imaging systems, it may be helpful to segment a patient's myocardium, for example, to calculate strain. For patients with heterogeneous myocardium thickness (e.g., HCM, or hypertrophic cardiomyopathy), the thickness of the Region of Interest (ROI)—in this case, the myocardium—is set uniformly across the length of the myocardium. This uniform thickness can be set by a user through an interface (e.g., a slider controller) that enables global, uniform adjustment of the thickness. However, to modify the ROI thickness regionally, such that the thickness is not uniform, users may need to manually select a control point within a specific region and adjust it to match the thickness of the myocardium. This manual process can be tedious, time-consuming, and may introduce errors.

Further limitations and disadvantages of conventional and traditional approaches will become apparent to one of skill in the art, through comparison of such systems with some aspects of the present disclosure as set forth in the remainder of the present application with reference to the drawings.

### SUMMARY

According to embodiments, a method for segmenting a moving anatomical structure in cine ultrasound data is described, the anatomical structure having a first boundary and a second boundary, wherein the second boundary moves between at least a portion of frames of the cine ultrasound data, the method comprising: determining a contour of the first boundary; establishing a plurality of landmark groups extending outwardly from the first boundary towards the second boundary, wherein each of the plurality of landmark groups includes a plurality of landmarks, wherein each of the landmarks corresponds to a given anatomical region; tracking locations of each of the plurality of landmarks over time in the cine ultrasound data to determine a motion characteristic for each of the plurality of landmarks; for each of the plurality of landmark groups, determining a difference between the motion characteristics of two adjacent landmarks to determine a corresponding transition point of the second boundary; and approximating the second boundary using the plurality of transition points. According to embodiments, the motion characteristic includes velocity. The motion characteristic may be determined using ultrasound image data from a plurality of frames. For each of the plurality of landmark groups, an inner one of the two adjacent landmarks may have a greater velocity than the outer one of the two adjacent landmarks. The first boundary may be an endocardial border, and wherein the second boundary may be an epicardial border. The thickness of the myocardium may be measured at different locations between the endocardial border and the epicardial border. A user may be able to adjust the shape (e.g., through a user interface) of the second boundary after the second boundary has been approximated. Each of the plurality of landmark groups may be a straight line. Each of the straight lines may extend perpendicularly from the first boundary. The ultrasound data may include two-dimensional or three-dimensional B-mode image data. The method may further include displaying the plurality of landmark groups on a display, wherein landmarks are displayed using different colors according to the motion characteristics for each of the landmarks.

According to embodiments, a system for segmenting a moving anatomical structure in cine ultrasound data is described, the anatomical structure having a first boundary and a second boundary, wherein the second boundary moves between at least a portion of frames of the cine ultrasound data, the system comprising: an ultrasound transducer configured to obtain data corresponding to the cine ultrasound data; a first boundary processor configured to determine a contour of the first boundary; a second boundary processor configured to determine a contour of the second boundary, wherein the second boundary processor is further configured to establish a plurality of landmark groups extending outwardly from the first boundary towards the second boundary, wherein each of the plurality of landmark groups includes a plurality of landmarks, wherein each of the landmarks corresponds to a given anatomical region, wherein the second boundary processor is further configured to track locations of each of the plurality of landmarks over time in the cine ultrasound data to determine a motion characteristic for each of the plurality of landmarks, wherein, for each of the plurality of landmark groups, the second boundary processor is further configured to determine a difference between the motion characteristics of two adjacent landmarks to determine a corresponding transition point of the second boundary, and wherein the second boundary processor is further configured to approximate the second boundary using the plurality of transition points. The motion characteristic may include velocity. The motion characteristic may be determined using ultrasound image data from a plurality of frames. For each of the plurality of landmark groups, an inner one of the two adjacent landmarks may have a greater velocity than the outer one of the two adjacent landmarks. The first boundary may be an endocardial border, and wherein the second boundary may be an epicardial border. The second boundary processor may be further configured to measure the thickness of the myocardium at different locations between the endocardial border and the epicardial border. The second boundary processor may be further configured to allow a user to adjust the shape of the second boundary after the second boundary has been approximated. Each of the plurality of landmark groups may include a straight line, and wherein each of the straight lines extends perpendicularly from the first boundary. The line may not be displayed to the user, but may be used by an algorithm as further described. The ultrasound data may include two-dimensional or three-dimensional B-mode image data. The second boundary processor may be further configured to display the plurality of landmark groups on a display, wherein landmarks are displayed using different colors according to the motion characteristics for each of the landmarks.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary ultrasound system that is operable for segmenting an anatomical structure that changes shapes, in accordance with various embodiments.

FIG. 2 depicts B-mode ultrasound image data of a patient's myocardium.

FIG. 3 depicts B-mode ultrasound image data of a patient's myocardium with the endocardial boundary identified.

FIG. 4 depicts B-mode ultrasound image data of a patient's myocardium with the endocardial boundary identified and landmarks extending outwardly from the endocardial boundary, according to embodiments.

FIG. 5 depicts B-mode ultrasound image data of a patient's myocardium with the endocardial boundary identified and landmarks extending outwardly from the endocardial boundary, where the landmarks indicate different motion characteristics of given anatomical regions, according to embodiments.

FIG. 6 depicts B-mode ultrasound image data of a patient's myocardium with the endocardial boundary identified and landmarks extending outwardly from the endocardial boundary, where the landmarks indicate different motion characteristics of given anatomical regions, wherein an epicardial boundary is identified based on the different motion characteristics, according to embodiments.

FIG. 7 depicts B-mode ultrasound image data of a patient's myocardium with the endocardial boundary and epicardial boundary identified, according to embodiments.

FIG. 8 is a flowchart for a method of segmenting an anatomical structure that changes shapes, according to embodiments.

### DETAILED DESCRIPTION

Certain anatomical structures may change shape over a relatively quick period of time. This may present some difficulty with segmenting such a structure. For example, in patients with heterogeneous myocardium thickness (e.g., hypertrophic cardiomyopathy), it may be difficult to accurately identify the epicardial border, especially as that border moves during function of the myocardium. While embodiments herein may refer to segmentation of the myocardium, techniques can be applied to other anatomical structures that move while functioning, such as cardiac valves.

When identifying the myocardium as a region of interest (ROI), some known techniques presume that the thickness between the endocardial border and epicardial border is uniform across the myocardium. This thickness can be adjusted uniformly across the ROI by a clinician (e.g., interacting with a slider controller). Some known techniques allow the clinician to manually adjust the thickness of the ROI such that it is not uniform throughout. Such manual adjustment can be performed by showing the endocardial border on B-mode image data, and also providing control points exterior from the endocardial border. The clinician can interact with the control points to adjust thickness of the ROI such that it is not uniform. Such manual adjustment can be time-consuming and relatively error-prone (for example, due to B-mode data in which the epicardial border is difficult to visually identify). Such known techniques may lead to relatively error-prone strain measurements, as well.

It can be helpful to accurately identify the myocardium, including myocardia in which the wall thickness is not uniform, in order to accurately calculate strain (the change in cardiac length from end-diastole (relaxation) to end-systole (contraction)).

According to embodiments disclosed herein, the endocardial border is presented on ultrasound image data (e.g., B-mode image data). The endocardial border may be identified using segmentation techniques, such as artificial intelligence (AI) or machine learning (ML) techniques. According to embodiments, the epicardial border can be subsequently identified by assessing a motion characteristic in the ultrasound image data, and determining the extent of the motion characteristic. Consider that the myocardium moves during function of the heart, but the space external to the myocardium (e.g., interstitial space) does not exhibit such motion. Techniques disclosed herein identify a boundary between where such motion characteristics exist and do not exist. In such a way, the epicardial border can be determined. Together with the endocardial border, the myocardium can be identified or segmented.

Certain embodiments may be found in a method and system for identifying one or more features, such as moving anatomical structures, in B-mode image data or other image data obtained by an ultrasound system. Such identification of feature(s) can use, in part a trained machine learning model and additional techniques that assess motion characteristic(s) of ultrasound data across multiple frames. Such motion characteristic(s) may be identified by tracking anatomical regions (e.g., via speckle tracking, such as 2D speckle tracking, such as such speckle tracking used in echocardiography) over two or more frames of ultrasound data in a set of cine ultrasound data.

Motion characteristic(s) may be used to determine a boundary between where such motion characteristic(s) exist and where they do not. In such a way, a boundary of an anatomical structure (e.g., epicardial border of the myocardium) can be determined. For example, if the myocardium proximate the epicardial border is expected to have a certain motion characteristic, the ultrasound data can be assessed across multiple frames to see if a given anatomical region does in fact have the expected motion characteristic. If so, the ultrasound system can determine that that anatomical region corresponds to the myocardium.

Aspects of the present disclosure have the technical effect of enhancing identification of moving anatomical structures (e.g., myocardium) in ultrasound image data in order to help provide a diagnosis. Various embodiments have the technical effect of segmenting a moving anatomical structure (e.g., myocardium) where the anatomical structure has non-uniform thickness across its length (as seen in the ultrasound image data, such as 2D ultrasound image data). Various embodiments have the technical effect of segmenting the anatomical structure, substantially in real-time as the anatomical structure moves. Various embodiments have the technical effect of improving strain calculations on the myocardium due to the improved segmentation.

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general-purpose signal processor or a block of random access memory, hard disk, or the like) or multiple pieces of hardware. Similarly, the programs may be standalone programs, may be incorporated as subroutines in an operating system, may be functions in an installed software package, and the like. It should be understood that the various embodiments are not limited to the arrangements and instrumentality shown in the drawings. It should also be understood that the embodiments may be combined, or that other embodiments may be utilized, and that structural, logical, and electrical changes may be made without departing from the scope of the various embodiments. The following detailed description is, therefore, not to be taken in a limiting sense, and the scope of the present disclosure is defined by the appended claims and their equivalents.

As used herein, an element or step recited in the singular and preceded with the word “a” or “an” should be understood as not excluding plural of said elements or steps, unless such exclusion is explicitly stated. Furthermore, references to “an exemplary embodiment,” “various embodiments,” “certain embodiments,” “a representative embodiment,” and the like are not intended to be interpreted as excluding the existence of additional embodiments that also incorporate the recited features. Moreover, unless explicitly stated to the contrary, embodiments “comprising”, “including”, or “having” an element or a plurality of elements having a particular property may include additional elements not having that property.

Also as used herein, the term “image” broadly refers to both viewable images and data representing a viewable image (image data). However, many embodiments generate (or are configured to generate) at least one viewable image. In addition, as used herein, the phrase “image” is used to refer to an ultrasound mode, which can be one-dimensional (1D), two-dimensional (2D), three-dimensional (3D), or four-dimensional (4D), and comprising Brightness mode (B-mode or, also referred to as spatial B-mode), Motion mode (M-mode), Color Motion mode (CM-mode), Color Flow mode (CF-mode), Pulsed Wave (PW) Doppler, Continuous Wave (CW) Doppler, Contrast Enhanced Ultrasound (CEUS), and/or sub-modes of B-mode and/or CF-mode such as Harmonic Imaging, Shear Wave Elasticity Imaging (SWEI), Strain Elastography, Tissue Velocity Imaging (TVI), Power Doppler Imaging (PDI), B-flow, Micro Vascular Imaging (MVI), Ultrasound-Guided Attenuation Parameter (UGAP), and the like.

Also, as used herein, the term “cine images” or “cine ultrasound images” or “cine ultrasound image data” or “cine ultrasound data” refers to two or more successive (not necessarily immediately successive) images obtained from corresponding frames. Cine ultrasound images can capture a given anatomical structure over time, including an anatomical structure that is to be segmented and/or is or is within an ROI.

Furthermore, the term processor or processing unit, as used herein, refers to any type of processing unit that can carry out the required calculations needed for the various embodiments, such as single or multi-core: CPU, Accelerated Processing Unit (APU), Graphic Processing Unit (GPU), Digital Signal Processor (DSP), Field-Programmable Gate Array (FPGA), Application-Specific Integrated Circuit (ASIC), or a combination thereof. A processor or processing unit may include multiple processors in the same location (e.g., integrated together in a single ASIC) or distributed over different locations. When there are multiple processors, they may communicate with other associated processors and/or work together to effect processing and computation.

It should be noted that various embodiments described herein that generate or form images may include processing for forming images that in some embodiments includes beamforming and in other embodiments does not include beamforming. For example, an image can be formed without beamforming, such as by multiplying the matrix of demodulated data by a matrix of coefficients so that the product is the image, and wherein the process does not form any “beams”. Also, forming of images may be performed using channel combinations that may originate from more than one transmit event (e.g., synthetic aperture techniques).

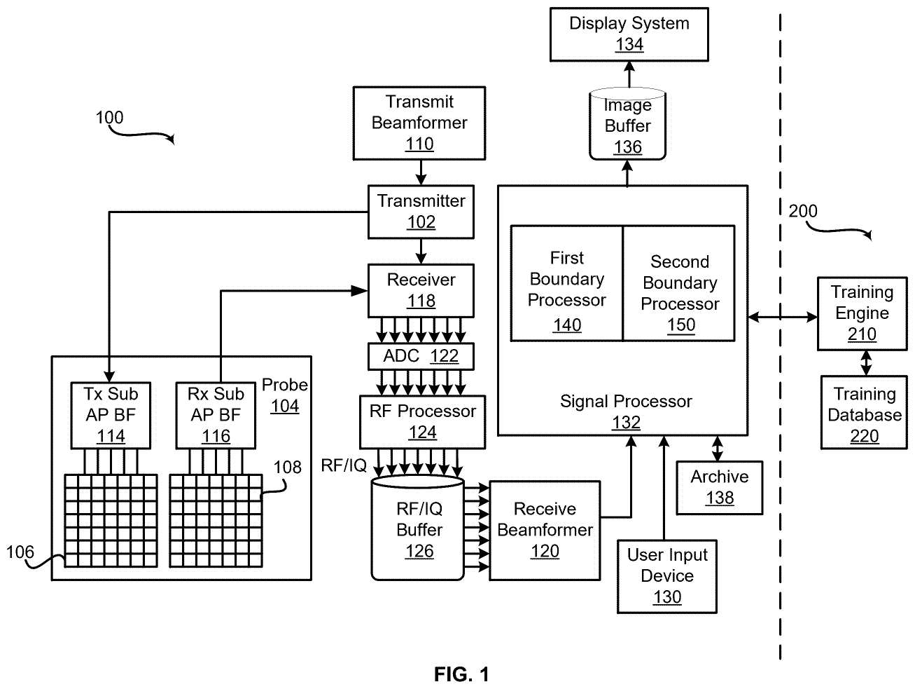

In various embodiments, ultrasound processing to form images is performed, for example, including ultrasound beamforming, such as receive beamforming, in software, firmware, hardware, or a combination thereof. One implementation of an ultrasound system having a software beamformer architecture formed in accordance with various embodiments is illustrated in FIG. 1.

FIG. 1 is a block diagram of an exemplary ultrasound system that is operable to identify features in image data obtained from a patient, in accordance with various embodiments. Referring to FIG. 1, there is shown an ultrasound system 100 and a training system 200. The ultrasound system 100 comprises a transmitter 102, an ultrasound probe 104, a transmit beamformer 110, a receiver 118, a receive beamformer 120, analog-to-digital (A/D) converters 122, a radio frequency (RF) processor 124, a RF quadrature (RF/IQ) buffer 126, a user input device 130, a signal processor 132, an image buffer 136, a display system 134, and an archive 138.

The transmitter 102 may comprise suitable logic, circuitry, interfaces, and/or code that may be operable to drive an ultrasound probe 104. The ultrasound probe 104 may be a linear, convex, intracavitary, or phased array transducer. The ultrasound probe 104 may comprise a two dimensional (2D) array of piezoelectric elements. The ultrasound probe 104 may comprise a group of transmit transducer elements 106 and a group of receive transducer elements 108, that normally constitute the same elements. The group of transmit transducer elements 106 may emit ultrasonic signals through oil and a probe cap and into a target. In a representative embodiment, the ultrasound probe 104 may be operable to acquire ultrasound image data covering at least a substantial portion of an anatomy, such as a myocardium, heart, liver, kidney, pancreas, spleen, kidney, or any suitable anatomical structure. In an exemplary embodiment, the ultrasound probe 104 may be operated in a volume acquisition mode, where the transducer assembly of the ultrasound probe 104 acquires a plurality of parallel 2D ultrasound slices forming an ultrasound volume.

The transmit beamformer 110 may comprise suitable logic, circuitry, interfaces and/or code that may be operable to control the transmitter 102 which, through a transmit sub-aperture beamformer 114, drives the group of transmit transducer elements 106 to emit ultrasonic transmit signals into a region of interest (e.g., human, animal, underground cavity, physical structure and the like). The transmitted ultrasonic signals may be back-scattered from structures in the object of interest, like blood cells or tissue, to produce echoes. The echoes are received by the receive transducer elements 108.

The group of receive transducer elements 108 in the ultrasound probe 104 may be operable to convert the received echoes into analog signals, undergo sub-aperture beamforming by a receive sub-aperture beamformer 116 and are then communicated to a receiver 118. The receiver 118 may comprise suitable logic, circuitry, interfaces and/or code that may be operable to receive the signals from the receive sub-aperture beamformer 116. The analog signals may be communicated to one or more of the plurality of A/D converters 122.

The plurality of A/D converters 122 may comprise suitable logic, circuitry, and interfaces and/or code that may be operable to convert the analog signals from the receiver 118 to corresponding digital signals. The plurality of A/D converters 122 are disposed between the receiver 118 and the RF processor 124. Notwithstanding, the disclosure is not limited in this regard. Accordingly, in some embodiments, the plurality of A/D converters 122 may be integrated within the receiver 118.

The RF processor 124 may comprise suitable logic, circuitry, interfaces, and/or code that may be operable to demodulate the digital signals output by the plurality of A/D converters 122. In accordance with an embodiment, the RF processor 124 may comprise a complex demodulator (not shown) that is operable to demodulate the digital signals to form me/Q data pairs that are representative of the corresponding echo signals. The RF or I/Q signal data may then be communicated to an RF/IQ buffer 126. The RF/IQ buffer 126 may comprise suitable logic, circuitry, interfaces, and/or code that may be operable to provide temporary storage of the RF or I/Q signal data, which is generated by the RF processor 124.

The receive beamformer 120 may comprise suitable logic, circuitry, interfaces and/or code that may be operable to perform digital beamforming processing to, for example, sum the delayed channel signals received from RF processor 124 via the RF/IQ buffer 126 and output a beam summed signal. The resulting processed information may be the beam summed signal that is output from the receive beamformer 120 and communicated to the signal processor 132. In accordance with some embodiments, the receiver 118, the plurality of A/D converters 122, the RF processor 124, and the beamformer 120 may be integrated into a single beamformer, which may be digital. In various embodiments, the ultrasound system 100 comprises a plurality of receive beamformers 120.

The user input device 130 may be utilized to input patient data, scan parameters, settings, select protocols and/or templates, select target structures for acquisition of images, input and/or select a region of interest, modify a region of interest, select regions of interest used to acquire images, a focused/zoomed volume, and the like. In an exemplary embodiment, the user input device 130 may be operable to configure, manage, and/or control operation of one or more components and/or modules in the ultrasound system 100. In this regard, the user input device 130 may be operable to configure, manage and/or control operation of the transmitter 102, the ultrasound probe 104, the transmit beamformer 110, the receiver 118, the receive beamformer 120, the RF processor 124, the RF/IQ buffer 126, the user input device 130, the signal processor 132, the image buffer 136, the display system 134, and/or the archive 138. The user input device 130 may include button(s), rotary encoder(s), a touchscreen, motion tracking, voice recognition, a mousing device, keyboard, camera, and/or any other device capable of receiving a user directive. In certain embodiments, one or more of the user input devices 130 may be integrated into other components, such as the display system 134 or the ultrasound probe 104, for example. As an example, user input device 130 may include a touchscreen display.

The signal processor 132 may comprise suitable logic, circuitry, interfaces and/or code that may be operable to process ultrasound scan data (e.g., summed IQ signal) for generating ultrasound images for presentation on a display system 134. The signal processor 132 is operable to perform one or more processing operations according to a plurality of ultrasound modalities (such as B-mode, Doppler, and color Doppler modalities) on the acquired ultrasound scan data. In an exemplary embodiment, the signal processor 132 may be operable to perform display processing and/or control processing, among other things. Acquired ultrasound scan data, such as spatial B-mode data, may be processed in real-time during a scanning session as the echo signals are received. Additionally or alternatively, the ultrasound scan data may be stored temporarily in the RF/IQ buffer 126 during a scanning session and processed in less than real-time in a live or off-line operation. In various embodiments, the processed image data can be presented at the display system 134 and/or may be stored at the archive 138. The archive 138 may be a local archive, a Picture Archiving and Communication System (PACS), or any suitable device for storing images and related information.

The signal processor 132 may be one or more central processing units, microprocessors, microcontrollers, and/or the like. The signal processor 132 may be an integrated component, or may be distributed across various locations, for example. In an exemplary embodiment, the signal processor 132 may comprise a first boundary processor 140 and a second boundary processor 150. The signal processor 132 may be capable of receiving input information from a user input device 130 and/or archive 138, generating an output displayable by a display system 134, and manipulating the output in response to input information from a user input device 130, among other things. The signal processor 132, the first boundary processor 140, and/or the second boundary processor 150 may be capable of executing any of the method(s) and/or set(s) of instructions discussed herein in accordance with the various embodiments, for example.

The ultrasound system 100 may be operable to generate cine ultrasound images by continuously or periodically acquiring ultrasound scan data at a frame rate that is suitable for the imaging situation in question (e.g., to track motion of a moving anatomical structure, such as a myocardium). Typical frame rates range from 20-120 per second but may be lower or higher. As used herein, a “time” or “period of time” may correspond to one or more frames. The acquired ultrasound scan data may be displayed on the display system 134 at a display-rate that can be the same as the frame rate, or slower or faster. A sequence of images (for example of a patient's blood flow) may be displayed simultaneously. An image buffer 136 is included for storing processed frames of acquired ultrasound scan data that are not scheduled to be displayed immediately. Preferably, the image buffer 136 is of sufficient capacity to store at least several minutes' worth of frames of ultrasound scan data. The frames of ultrasound scan data are stored in a manner to facilitate retrieval thereof according to its order or time of acquisition. The image buffer 136 may be embodied as any known data storage medium.

The signal processor 132 may include a first boundary processor 140 that comprises suitable logic, circuitry, interfaces, and/or code that may be operable to use an ultrasound probe 104 to determine a first boundary of an anatomical structure (e.g., myocardium) in ultrasound image data. In an exemplary embodiment, the first boundary processor 140 may be configured to receive image data (e.g., 2D B-mode image data, or a portion thereof, such as data in a region of interest) and identify a first boundary (e.g., endocardial boundary in a myocardium) in the anatomical structure. The first boundary processor 140 may use or work with a trained machine learning algorithm (e.g., via the training engine 210 and/or training database 220) to identify or segment the first boundary. The first boundary processor 140 may separately identify the first boundary of the anatomical structure in each of a plurality of frames in cine ultrasound images. Segmentation or identification of the first boundary of the anatomical structure may be performed in 2D or 3D data. In the case of 3D data, the first boundary of the anatomical structure can be determined in either two dimensions or three dimensions. The first boundary of the anatomical structure may move or change shapes between different frames.

The display system 134 may be any device capable of communicating visual information to a user. For example, a display system 134 may include a liquid crystal display, a light emitting diode display, and/or any suitable display or displays. The display system 134 can be operable to present 2D ultrasound images, 2D sequential ultrasound images, biplane ultrasound images, biplane ultrasound slices extracted from 3D/4D volumes, rendered 3D/4D volumes, selectable target structures, and/or any suitable information.

The archive 138 may be one or more computer-readable memories integrated with the ultrasound system 100 and/or communicatively coupled (e.g., over a network) to the ultrasound system 100, such as a Picture Archiving and Communication System (PACS), a server, a hard disk, floppy disk, CD, CD-ROM, DVD, compact storage, flash memory, random access memory, read-only memory, electrically erasable and programmable read-only memory and/or any suitable memory. The archive 138 may include databases, libraries, sets of information, or other storage accessed by and/or incorporated with the signal processor 132, for example. The archive 138 may be able to store data temporarily or permanently, for example. The archive 138 may be capable of storing medical image data, data generated by the signal processor 132, and/or instructions readable by the signal processor 132, among other things. In various embodiments, the archive 138 stores 2D ultrasound images, 2D sequential ultrasound images, biplane ultrasound images, biplane ultrasound slices extracted from 3D/4D volumes, rendered 3D/4D volumes, instructions for acquiring ultrasound image data, instructions for producing cine ultrasound images, instructions for generating sample cine ultrasound images, instructions for classifying images as generated or real, instructions for providing feedback based on the classifying of images, instructions for determining that an objective function has been reached, for example.

Components of the ultrasound system 100 may be implemented in software, hardware, firmware, and/or the like. The various components of the ultrasound system 100 may be communicatively linked. Components of the ultrasound system 100 may be implemented separately and/or integrated in various forms. For example, the display system 134 and the user input device 130 may be integrated as a touchscreen display.

Still referring to FIG. 1, the training system 200 may comprise a training engine 210 and a training database 220. The training engine 210 may comprise suitable logic, circuitry, interfaces and/or code that may be operable to train the neurons of the deep neural network(s) (e.g., artificial intelligence model(s)) inferenced (i.e., deployed) by the first boundary processor 140. For example, the machine-learning model implemented by first boundary processor 140 may be trained to identify features such as a boundary in an anatomical structure obtained by ultrasound system 100.

In various embodiments, the databases 220 of training images may be a Picture Archiving and Communication System (PACS), or any suitable data storage medium. In certain embodiments, the training engine 210 and/or training image databases 220 may be remote system(s) communicatively coupled via a wired or wireless connection to the ultrasound system 100 as shown in FIG. 1. Additionally and/or alternatively, components or all of the training system 200 may be integrated with the ultrasound system 100 in various forms. In some examples, the training image databases may include reference cine ultrasound images of anatomical structures.

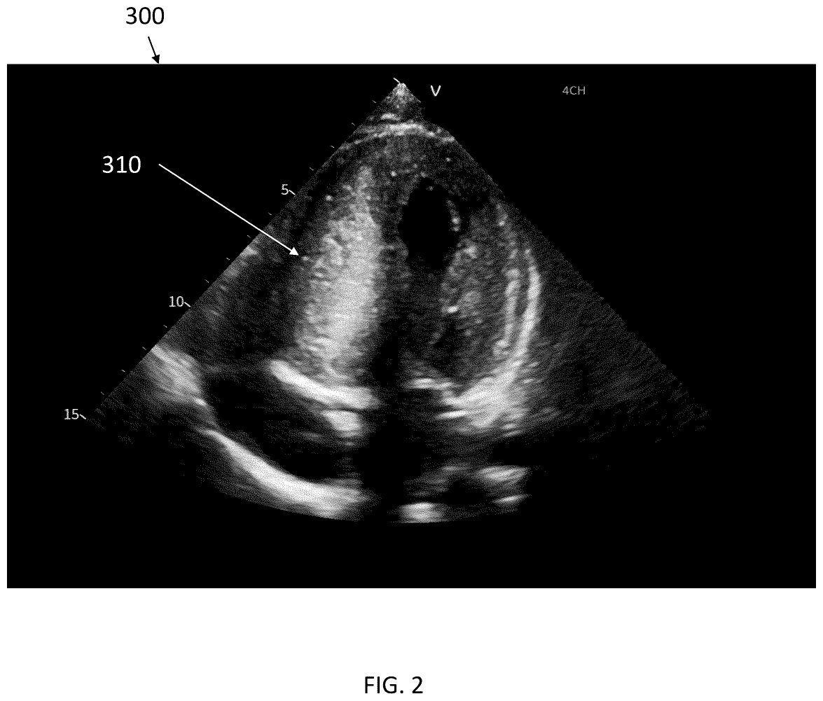

FIG. 2 shows one frame of 2D B-mode image data 300 including a patient's myocardium 310. While 2D B-mode image data 300 is exemplary ultrasound image data described herein, other image data could also be used, such as the types of image data described above. In systems that are multimodal (e.g., are capable of obtaining B-mode image data and other types of image data, such as Doppler image data), multiple types of image data may be used. While the myocardium 310 is used as an exemplary anatomical structure, other anatomical structures, and particularly moving anatomical structures could be used, examples of which include cardiac valve(s). The myocardium 310 may be or may be in a ROI. The myocardium 310 may ultimately be segmented or identified and then become the ROI or a part of the ROI. The B-mode image data 300 may be presented on a display system 134 for viewing by a user. The user may “manually” draw (draw through the user input device 130) or position an ROI and/or positioned by a user in the ultrasound image data 300 according to clinical purposes. Within the ROI, the myocardium 310 may later be identified or segmented as further discussed.

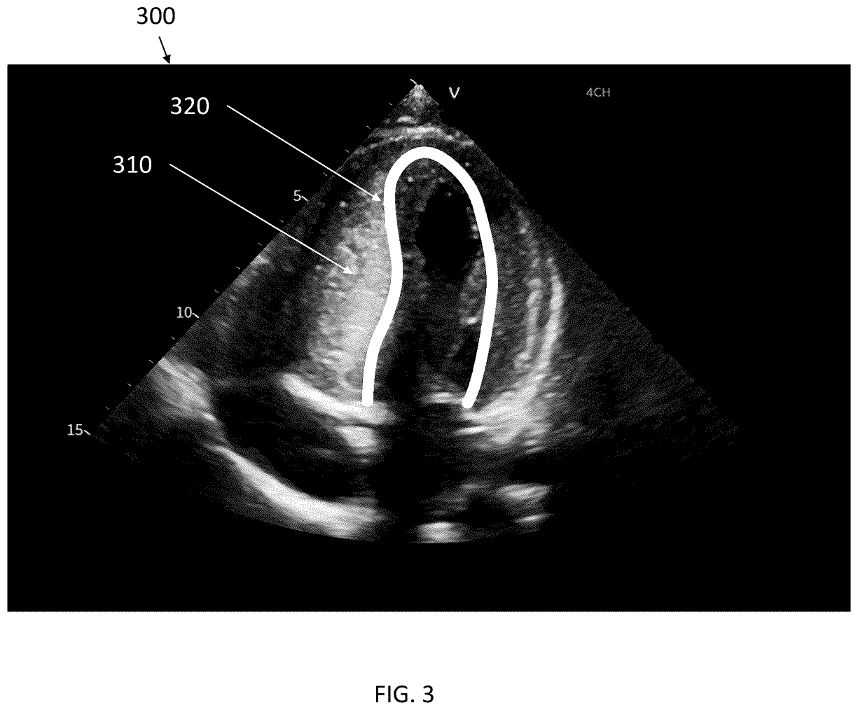

Referring again to FIG. 1, the first boundary processor 140 may be configured to gather ultrasound image data as the ultrasound probe 104 is glided across an ROI, an anatomical structure and/or fluids contained therein (such as blood flowing through a region of interest of a patient's cardiovascular system). As the ultrasound probe 104 is glided across such a region, the first boundary processor 140 gathers ultrasound image(s) and identifies a first boundary of the anatomical structure. The data provided to the first boundary processor 140 may be stored at archive 138 and/or any suitable computer readable medium, and the first boundary processor 140 may obtain the ultrasound image data from the archive 138 and/or any suitable computer readable medium. The first boundary processor 140 may generate the endocardial border shown in FIGS. 3-7.

FIG. 3 illustrates ultrasound image data 300 (one frame of B-mode image data) including the myocardium 310, in which the contour of an endocardial boundary 320 (a type of first boundary) has been identified by the first boundary processor 140. As discussed, the contour of the endocardial boundary 320 (hereinafter, endocardial boundary) can be determined by the first boundary processor 140 in conjunction with artificial intelligence or machine learning techniques, and may operate in conjunction with the training engine 210 and training database 220. Alternatively, the endocardial boundary 320 may be received via user input from the user input device 130 (e.g., a user manually traces the shape of the first boundary 320 on a touch screen). Alternatively, the endocardial boundary 320 may be identified by the first boundary processor 140 using different techniques, such as edge-detection algorithms.

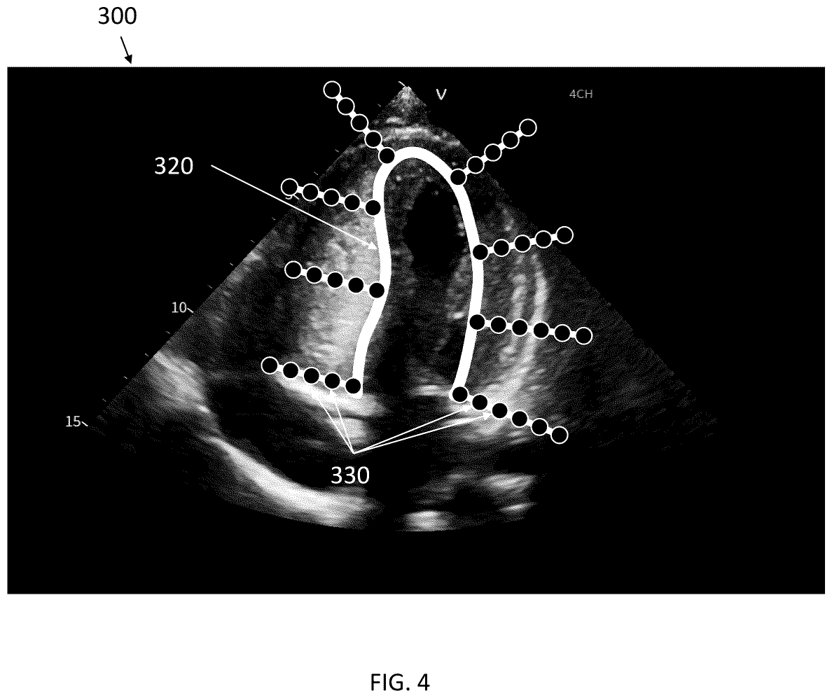

FIG. 4 illustrates ultrasound image data 300 (one frame of B-mode image data) including the myocardium 310 with the endocardial boundary 320 identified and landmarks 330 extending outwardly from the endocardial boundary 320 towards the epicardial boundary, according to embodiments. Landmarks 330 may extend from the endocardial boundary 320 at select locations on the endocardial boundary 320 (e.g., where a given landmark 330 intersects the endocardial boundary 320). Those select locations may be sampled at consistent intervals along the endocardial boundary 320. As shown, there are eight such locations, although more or fewer are possible. When more such locations are selected, the epicardial boundary 340 (not shown in FIG. 4) may be identified with greater resolution, however this may require a greater amount of processing, which may be inconsistent with a potential goal of segmenting the myocardium 310 substantially in real time as the myocardium 310 moves from frame to frame.

From each selected location on the endocardial boundary 320, the landmarks 330 are extended outwardly (additional landmarks 330 are populated) in landmark groups from the endocardial boundary 320. The landmarks 330 in a landmark group can be located along a straight line, and can be located at consistent intervals from each other. As shown, each line of landmarks 330 in a landmark group includes five landmarks 330, although more or fewer are possible. More landmarks 330 in a landmark group may allow for greater resolution, but at the expense of greater processing. A given line of landmarks 330 in a landmark group can extend perpendicularly from a tangent at the endocardial boundary 320 at which they extend from. Thus, at a given location on the endocardial boundary 320, the curve has a tangent, and the line of landmarks 330 in a landmark group extends perpendicularly from that tangent. Each landmark 330 corresponds to a unique anatomical region indicated in the ultrasound image data 300. Each such anatomical region has a characteristic. Such anatomical region(s) may move during ultrasound imaging, between different positions on different ultrasound image frames. Each such characteristic of an anatomical region can have a speckle pattern that can be tracked from frame-to-frame of cine sequences of ultrasound image data 300. Thus, motion characteristic(s) can be assessed for each of the anatomical regions corresponding to given landmarks 330 between two or more frames of ultrasound image data 300. The landmarks 330 can move with the given corresponding anatomical regions, or the landmarks 330 can be stationary but may be used to account for movement of tissue or fluid in the patient's anatomy as indicated by the ultrasound image data 300. In the case that the landmarks 330 remain stationary, they can be used to determine motion characteristic(s) of given anatomical areas of the patient's anatomy based on movement from frame-to-frame in a sequence of ultrasound image data 300. Generally, motion characteristic(s) can be assessed between sequential frames of ultrasound image data 300, or from regular intervals of frames (e.g., every second frame, third frame, etc.). Such motion characteristics can include velocity, acceleration, and/or jerk of the given anatomical regions corresponding to the landmarks 330. Such motion characteristics can indicate a specific value (e.g., a specific value of velocity, acceleration, and/or jerk), or a range of values. The second boundary processor 150 may operate to cause one or more of the aforementioned operations in conjunction with FIG. 4.

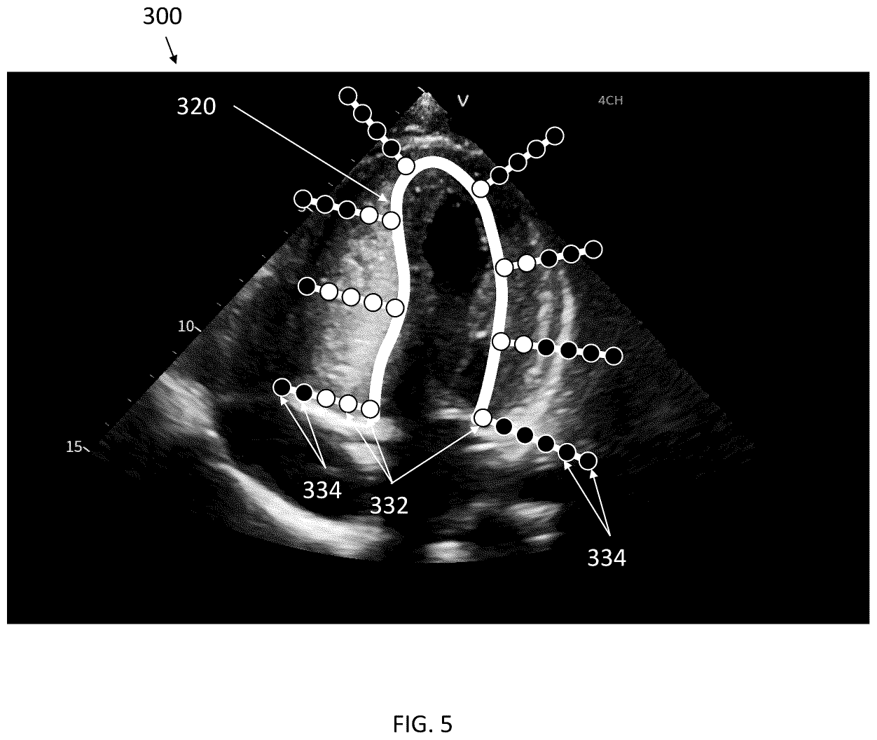

FIG. 5 illustrates ultrasound image data 300 (one frame of B-mode image data) including the myocardium 310 with the endocardial boundary 320 identified and landmarks 330 in corresponding landmark groups extending outwardly from the endocardial boundary 320 towards the epicardial boundary, where the landmarks 330 include landmarks 332, 334, which indicate different motion characteristics of the anatomical regions corresponding to the landmarks 330, according to embodiments. Landmarks 332 are shown as white circles, and indicate a first motion characteristic. Landmarks 334 are shown as black circles and indicate a second motion characteristic. Generally, landmarks 332, 334 may be visually distinguished from each other when shown on display 134, such as with different colors, patterns, gradients, etc. In the embodiment of FIG. 5, the landmarks 334 correspond to a greater range of velocities and the landmarks 332 correspond to a lesser range of velocities of the corresponding anatomical regions.

The endocardial boundary 320 also moves from frame-to-frame. The contour of the endocardial boundary 320 may be determined on a frame-by-frame basis or at multiple frames, for example, by machine learning algorithm(s). Landmarks 332 that are proximate the endocardial boundary 320 may have similar motion characteristics as the endocardial boundary 320. The tissue corresponding to the endocardial boundary 320 and proximate landmarks 322 may be part of a homogenous tissue area. In contrast, landmarks 334 may not correspond to the myocardium 310, and rather may be part of a tricuspid valve, which may have tissue that moves at a greater velocity than the tissue of the myocardium 310. The second boundary processor 150 may operate to cause one or more of the aforementioned operations in conjunction with FIG. 5.

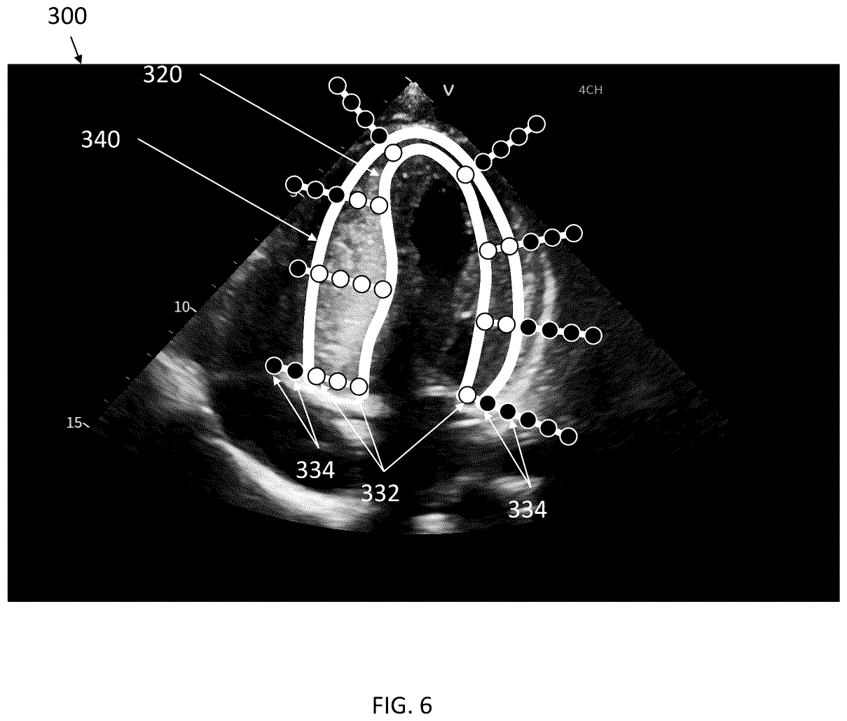

FIG. 6 illustrates ultrasound image data 300 (one frame of B-mode image data) including the myocardium 310 with the endocardial boundary 320 identified and landmarks 330 in given landmark groups extending outwardly from the endocardial boundary 320, where the landmarks 330 indicate different motion characteristics 332, 334 of the anatomical regions corresponding to the landmarks 330, and where the epicardial boundary 340 has been determined, according to embodiments. A point of a contour of the epicardial boundary 340 (hereinafter, epicardial boundary) is determined to be along a location generally between adjacent landmarks 332, 334 in a given landmark group having different motion characteristics from each other. Two such adjacent landmarks 332, 334 can indicate a transition point. The contour of the epicardial boundary 340 may be determined this way at select transition points, and a curve can be fit along these transition points to estimate the location of the epicardial boundary 340. The second boundary processor 150 may operate to cause one or more of the aforementioned operations in conjunction with FIG. 6.

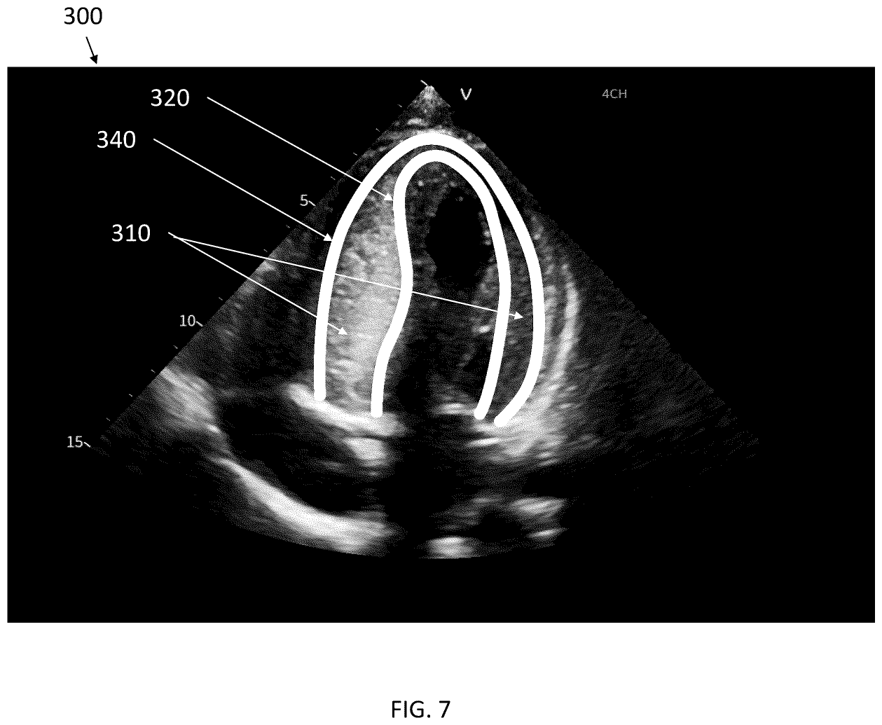

FIG. 7 illustrates ultrasound image data 300 (one frame of B-mode image data) including the myocardium 310, where both the endocardial boundary 320 and the epicardial boundary 340 have been identified, according to embodiments. A user may adjust the shape of the epicardial boundary 340, for example, through the user input device 130. Such adjustments may be on a frame-by-frame basis, or may apply to multiple frames (e.g., groups of frames corresponding to the same heart phase). Once the endocardial boundary 320 and the epicardial boundary 340 have been determined, the myocardium 310 may be considered to be segmented. Distance(s) (corresponding to thickness(es)) between the endocardial boundary 320 and the epicardial boundary 340 can be determined. The second boundary processor 150 may operate to cause one or more of the aforementioned operations in conjunction with FIG. 7.

According to embodiments, epicardial boundary 340 delineation can be used for strain analysis, resulting in improved accuracy of strain measurements, especially in patients with heterogenous wall thickness in the myocardium 310. In addition to speckle tracking to determine the epicardial boundary 340, additional speckle tracking can be used to determine strain. Strain corresponds to the change in cardiac length (thickness of myocardium 310) from end-diastole (relaxation) to end-systole (contraction). Strain may be assessed in terms of the percentage of shortening (contraction) or lengthening (relaxation) in given regions of the myocardium 310 between the endocardial boundary 320 and the epicardial boundary 340. Strain may be expressed as a percentage of such shortening or lengthening. For example, if a thickness shortens from ten to eight (where ten and eight are arbitrary), the strain may be-20%. On the other hand, if the thickness lengthens from eight to ten, the strain may be 20%.

Strain may be addressed in more than one dimension. In a radial dimension, radial strain is the change in the myocardium thickness, as discussed above. In a longitudinal dimension, longitudinal strain measures the cardiac length as the distance from the left base to the right base along the curve through the apex. Techniques disclosed herein can improve strain calculations (procedure or result) in the longitudinal dimension as well as the radial dimension.

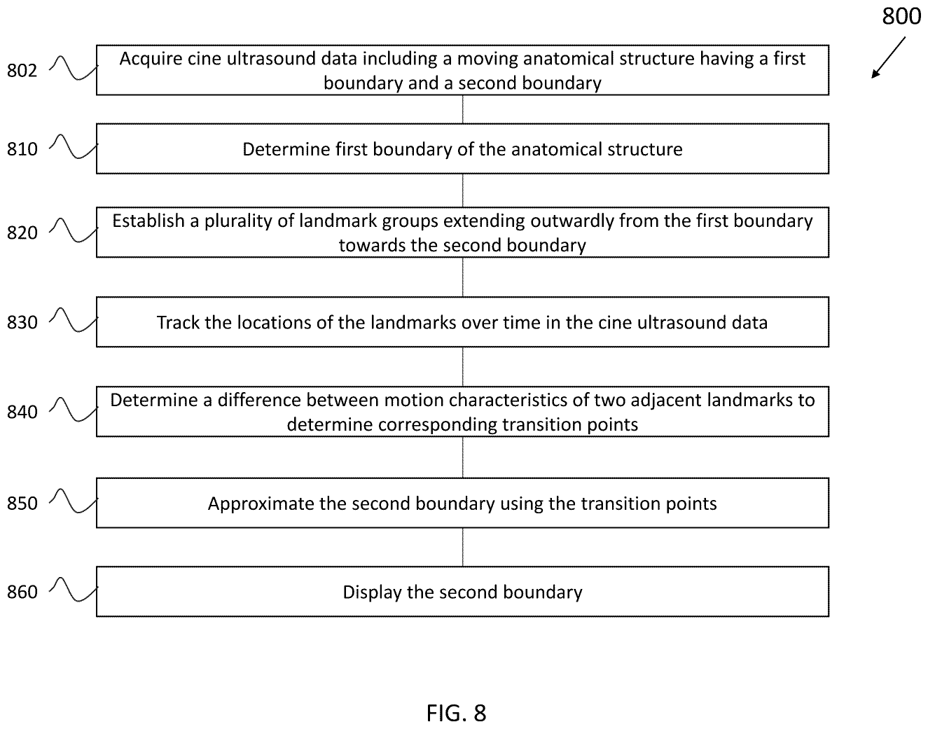

FIG. 8 is a flowchart 800 for a method of segmenting an anatomical structure that changes shapes, according to embodiments. Reference is made to the foregoing reference numerals and contexts, but the method is not so limited. In the example described below, the specific anatomical structure referred to is a myocardium 310. Steps may be omitted, performed in a different order, or may overlap. The method can be performed by a system, such as ultrasound system 100, including signal processor 132, inclusive of first boundary processor 140 and/or second boundary processor 150.

At step 802, as discussed above, cine ultrasound data is acquired by ultrasound system 100. As discussed above, such acquisition can be achieved through use of the ultrasound probe 104, including transmit transducer elements 106 and receive transducer elements 108. As discussed above, such acquisition can be achieved through operation of signal processor 132.

At step 810, a contour of the first boundary (e.g., endocardial boundary 320) of the anatomical structure (e.g., myocardium 310) is determined. As discussed above, such a determination can be performed by the first boundary processor 140, and may involve machine learning techniques, including implementation of a machine learning model at least partially embodied in training engine 210 and/or training database 220.

At step 820, a plurality of landmark groups are established, where they extend outwardly from the first boundary towards a second boundary (e.g., epicardial boundary 340) of the anatomical structure. Each landmark group includes a plurality of landmarks 330, and each landmark corresponds to a given anatomical region identifiable in the ultrasound image data 300. The landmark groups may extend perpendicularly from the first boundary. As discussed above, one or more operations of step 820 may be performed by the second boundary processor 150.

At step 830, the locations of each of the plurality of landmarks are tracked over time in cine ultrasound image data to determine motion characteristic(s) for each of the landmarks 330. Tracking may be performed by speckle tracking. The motion characteristic(s) can include velocity, acceleration, and/or jerk. As discussed above, one or more operations of step 830 may be performed by the second boundary processor 150.

At step 840, for each of the landmark groups, a difference between the motion characteristics of two adjacent landmarks 330 is determined. If the difference between the motion characteristics between the two adjacent landmarks 330 satisfies a predetermined condition, such as exceeding threshold(s) for differential(s) in velocity, acceleration, and/or jerk between the two adjacent landmarks 330, then a corresponding transition point may be determined between the two adjacent landmarks 330. The transition points correspond to locations on the second boundary. As discussed above, one or more operations of step 840 may be performed by the second boundary processor 150.

At step 850, the second boundary is approximated using the plurality of transition points. For example, a curve may be fit to the plurality of transition points. As discussed above, one or more operations of step 850 may be performed by the second boundary processor 150.

At step 860, the display system 134 may present a display of the second boundary, and such a presentation on the display system 134 may be caused by the signal processor 132.

As utilized herein the term “circuitry” refers to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” and/or “configured” to perform a function whenever the circuitry comprises the necessary hardware and code (if any is necessary) to perform the function, regardless of whether performance of the function is disabled, or not enabled, by some user-configurable setting.

Other embodiments may provide a computer readable device and/or a non-transitory computer readable medium, and/or a machine readable device and/or a non-transitory machine readable medium, having stored thereon, a machine code and/or a computer program having at least one code section executable by a machine and/or a computer, thereby causing the machine and/or computer to perform the steps as described herein for enhancing sequential ultrasound images using deep learning.

Accordingly, the present disclosure may be realized in hardware, software, or a combination of hardware and software. The present disclosure may be realized in a centralized fashion in at least one computer system, or in a distributed fashion where different elements are spread across several interconnected computer systems. Any kind of computer system or other apparatus adapted for carrying out the methods described herein is suited.

Various embodiments may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A method for segmenting a moving anatomical structure in cine ultrasound data, the anatomical structure having a first boundary and a second boundary, wherein the second boundary moves between at least a portion of frames of the cine ultrasound data, the method comprising:
acquiring, by an ultrasound transducer of an ultrasound system, the cine ultrasound data;
determining, by at least one processor of the ultrasound system, a contour of the first boundary;
establishing, by the at least one processor, a plurality of landmark groups extending outwardly from the first boundary towards the second boundary, wherein each of the plurality of landmark groups includes a plurality of landmarks, wherein each of the landmarks corresponds to a given anatomical region;
tracking, by the at least one processor, locations of each of the plurality of landmarks over time in the cine ultrasound data to determine a motion characteristic for each of the plurality of landmarks;
for each of the plurality of landmark groups, determining by the at least one processor, a difference between the motion characteristics of two adjacent landmarks to determine a corresponding transition point of the second boundary;
approximating by the at least one processor, the second boundary using the plurality of transition points; and
causing, by the at least one processor, a display system of the ultrasound system to present the second boundary.

2. The method of claim 1, wherein the motion characteristic comprises velocity.

3. The method of claim 2, wherein the motion characteristic is determined using ultrasound image data from a plurality of frames.

4. The method of claim 2, wherein, for each of the plurality of landmark groups, an inner one of the two adjacent landmarks has a greater velocity than the outer one of the two adjacent landmarks.

5. The method of claim 1, wherein the first boundary comprises an endocardial border, and wherein the second boundary comprises an epicardial border.

6. The method of claim 5, further comprising measuring the thickness of the myocardium at different locations between the endocardial border and the epicardial border.

7. The method of claim 5, further comprising allowing a user to adjust the shape of the second boundary after the second boundary has been approximated.

8. The method of claim 1, wherein each of the plurality of landmark groups comprises a straight line, and wherein each of the straight lines extends perpendicularly from the first boundary.

9. The method of claim 1, wherein the ultrasound data comprises two-dimensional B-mode image data.

10. The method of claim 1, wherein landmarks are displayed using different colors according to the motion characteristics for each of the landmarks.

11. A system for segmenting a moving anatomical structure in cine ultrasound data, the anatomical structure having a first boundary and a second boundary, wherein the second boundary moves between at least a portion of frames of the cine ultrasound data, the system comprising:
an ultrasound transducer configured to obtain data corresponding to the cine ultrasound data;
a first boundary processor configured to determine a contour of the first boundary;
a second boundary processor configured to determine a contour of the second boundary, wherein the second boundary processor is further configured to establish a plurality of landmark groups extending outwardly from the first boundary towards the second boundary, wherein each of the plurality of landmark groups includes a plurality of landmarks, wherein each of the landmarks corresponds to a given anatomical region,
wherein the second boundary processor is further configured to track locations of each of the plurality of landmarks over time in the cine ultrasound data to determine a motion characteristic for each of the plurality of landmarks,
wherein, for each of the plurality of landmark groups, the second boundary processor is further configured to determine a difference between the motion characteristics of two adjacent landmarks to determine a corresponding transition point of the second boundary, and
wherein the second boundary processor is further configured to approximate the second boundary using the plurality of transition points.

12. The system of claim 11, wherein the motion characteristic comprises velocity.

13. The system of claim 12, wherein the motion characteristic is determined using ultrasound image data from a plurality of frames.

14. The system of claim 12, wherein, for each of the plurality of landmark groups, an inner one of the two adjacent landmarks has a greater velocity than the outer one of the two adjacent landmarks.

15. The system of claim 11, wherein the first boundary comprises an endocardial border, and wherein the second boundary comprises an epicardial border.

16. The system of claim 15, wherein the second boundary processor is further configured to measure the thickness of the myocardium at different locations between the endocardial border and the epicardial border.

17. The system of claim 15, wherein the second boundary processor is further configured to allow a user to adjust the shape of the second boundary after the second boundary has been approximated.

18. The system of claim 11, wherein each of the plurality of landmark groups comprises a straight line, and wherein each of the straight lines extends perpendicularly from the first boundary.

19. The system of claim 11, wherein the ultrasound data comprises two-dimensional B-mode image data.

20. The system of claim 11, wherein the second boundary processor is further configured to display the plurality of landmark groups on a display, wherein landmarks are displayed using different colors according to the motion characteristics for each of the landmarks.
